(19) United States
(12) Patent Application Publication
(10) Pub. No.: US 2003/0228172 A1
(43) Pub. Date: Dec. 11, 2003

(54) Charging apparatus

(75) Inventors: Ryo Nakamura, Shizuoka (JP); Hiroyuki Suzuki, Kanagawa (JP); Ryo Inoue, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/429,864

(22) Filed: May 6, 2003

(30) Foreign Application Priority Data
May 8, 2002 (JP) 133248/2002(PAT.)
Jun. 25, 2002 (JP) 185254/2002(PAT.)

(51) Int. Cl. G03G 15/02

(52) U.S. Cl. 399/174; 399/175; 399/176

(57) ABSTRACT

The charging apparatus includes plural charging devices including a first charging device and a second charging device, in which an absolute value of a current flowing from the second charging device to a member to be charged is 25% or less of an absolute value of a sum of currents respectively flowing from the plural charging devices to the member to be charged, thereby achieving uniform charging of the member to be charged.

### BACKGROUND OF THE INVENTION

1. Field of the Invention

The present invention relates to a charging apparatus having plural charging means which charges a charged member. Such charging apparatus is preferably used in an image forming apparatus for image formation by an electrophotographic process or the like, such as a copying apparatus, a printer or a facsimile.

2. Description of Related Art

In an image forming apparatus utilizing an electrophotographic process such as a copying machine, a printer or a facsimile, an electrophotographic photosensitive member 101 (hereinafter called photosensitive member) constituting an image bearing member is uniformly charged by a corona charger (charging device) 102 constituting charging means, and the surface of the charged photosensitive member 101 is subjected to an image exposure L by an exposure apparatus 103 to form an electrostatic latent image. Such electrostatic latent image is developed by a developing sleeve 104a of a developing apparatus 104 to form a toner image, which is transferred by a transfer roller 105 onto a transfer material P such as paper, thereby achieving an image formation.

Also residual toner, remaining on the surface of the photosensitive member after the transfer is removed by a cleaning blade 106, and the photosensitive member 101 is exposed to a pre-exposure lamp 107 to eliminate an optical memory of the image exposure, thereby being prepared for a next image formation.

As a photosensitive member to be employed in the aforementioned image forming apparatus, an organic photosensitive member and an amorphous silicon photosensitive member (hereinafter represented as “a-Si photosensitive member”) are widely employed, and the a-Si photosensitive member is particularly employed as an electrophotographic photosensitive member for a high-speed copying machine or a laser beam printer (LBP) because it has a high surface hardness, a high sensitivity to a semiconductor laser or the like and scarce deterioration in repeated use.

For charging such a-Si photosensitive member, there are known, for example, a corona charging method utilizing a corona discharge, a roller charging method for charging by a direct discharge utilizing a conductive roller, and an injection charging method of directly injecting a charging into the surface of the photosensitive member, by securing a sufficient contact area for example with magnetic particles.

The corona charging method or the roller charging method mentioned above, utilizing a discharge, tends to cause a deposition of a discharge product on the surface of the photosensitive member. In addition, as the discharge product tends to remain on the surface of the photosensitive member because the a-Si photosensitive member has a very high surface hardness and is not easily abraded, the charge on the surface of the photosensitive member bearing an electrostatic latent image moves along the surface thereof, for example by a moisture adsorption under a high moisture environment, thereby resulting in an image streaking phenomenon.

On the other hand, in the aforementioned injection charging method, based on direct charge injection from a part in contact with the surface of the photosensitive member, the aforementioned image streaking phenomenon is less likely to appear.

In the a-Si photosensitive member, which is prepared by turning a gas into a plasma by a high frequency current or a microwave and depositing it as a solid film on an aluminum cylinder, the film thickness or the composition becomes uneven in the circumferential direction unless the plasma is generated uniformly.

Also in the image exposure of the charged photosensitive member in the exposure apparatus, a potential on the photosensitive member is attenuated (lowered) in an exposed portion (light area), and, in the a-Si photosensitive member, a potential attenuation becomes much larger even in a dark area (non-exposed portion) in comparison with an organic photosensitive member and also increases by an optical memory effect of the image exposure, so that it is preferable to provide pre-exposure means in front of the charging, in order to erase the optical memory of the preceding cycle.

For this reason, there results a very large potential attenuation, about 100 to 200 V, between a charging position and a developing position on the photosensitive member along the rotating direction thereof. In addition, because of the aforementioned unevenness in the film thickness of the a-Si photosensitive member, there results a potential unevenness of about 10 to 20 V along the circumferential direction of the photosensitive member.

In particular, the a-Si photosensitive member, having a larger electrostatic capacitance in comparison with the organic photosensitive member, is more strongly influenced by such potential unevenness, and shows an unevenness in the image density more conspicuously.

Against such drawback, it is effective to employ for example a method of charging plural times. In such method of such plural chargings against the aforementioned increase in the potential attenuation in the dark area resulting from the optical memory effect, since-the optical memory can be significantly reduced in a first charging, the potential attenuation in the dark area can be reduced after a second charging. It is therefore possible to significantly alleviate a potential ghost phenomenon or a potential unevenness.

However, the charging with plural injection charging devices can significantly alleviate the potential ghost phenomenon or the potential unevenness but tends to enhance the abrasion of the surface of the photosensitive member, since contact points with the photosensitive member are required in a larger number for charge injection, for example, in case of a magnetic brush charger, since a magnetic particle carrying member is moved opposite to the moving direction of the photosensitive member to cause a frictional motion of the magnetic particles.

The a-Si photosensitive member, having a very hard surface, can provide a certain endurance even in case of using plural magnetic brush chargers, but there is desired a higher endurance because the photosensitive member is associated with a high cost because of the manufacturing process thereof. On the other hand, in case of charging the a-Si photosensitive member with a plural charging system employing corona chargers or roller chargers based on discharges, there can be obtained a high endurance against the abrasion but an image streak phenomenon tends to appear because of the deposition of a discharge product as explained in the foregoing.

Also in an a-Si photosensitive member, in order to employ plural charging means for alleviating the potential ghost phenomenon and the potential unevenness and to achieve an improvement in the abrasion resistance and a prevention of the image streak at the same time, it is effective to combine the aforementioned injection charging method and a method of lower friction such as a corona charging method or a roller charging method.

Such combination of the injection charging method and the corona charging method of the roller charging method allows to eliminate the discharge product, generated by the corona charging or the roller charging, by the friction of the injection charger, and to maintain the abrasion of the photosensitive member almost at a level of a case of employing an injection charger only, by reducing a coating amount of the magnetic particles on the magnetic particle carrying (bearing) member thereby decreasing the frictional force.

Also even in case of employing plural magnetic brush chargers, it may be possible to realize an acceptable drum service life by reducing the coating amount of the magnetic particles thereby decreasing the frictional force.

However, a reduction in the coating amount of the magnetic particles for decreasing the frictional force results in a decrease of the charging ability of the magnetic particle carrying member, eventually leading to a conspicuous unevenness in the charging ability. Also, other charging means, for example the roller charger, results in an unevenness in the charging ability in case toner or dust is deposited on the roller surface.

In particular, in case an unevenness in the charging ability results in the lowermost charging means (most downstream side) in the moving direction of the photosensitive member, it becomes difficult to apply a uniform charging on the surface of the photosensitive member, thereby causing a significant influence on the output image.

### SUMMARY OF THE INVENTION

An object of the present invention is to provide a charging apparatus capable of uniformly charging a member to be charged.

Another object of the present invention is to provide a charging apparatus capable of preventing generation of an unevenness in the charging ability.

A further object of the present invention is to provide a charging apparatus capable of charging a member to be charged in stable manner over a prolonged period.

A further object of the present invention is to provide a charging apparatus capable of charging a member to be charged with plural charging means.

A further object of the present invention is to provide a charging apparatus adapted for charging an amorphous silicon photosensitive member.

A still further objects of the present invention, and features thereof, will become fully apparent from the following detailed description, which is to be taken in conjunction with the accompanying drawings.

### BRIEF DESCRIPTION OF THE DRAWINGS

FIG. 1 is a schematic view showing the configuration of an image forming apparatus constituting embodiments 1 and 2 of the present invention;

FIG. 2 is a view showing the configuration of a charging apparatus in the embodiment 1 of the present invention;

FIG. 3 is a table showing results of evaluation on a correlation, in case charging biases are applied to a magnetic brush charger and a charging roller in the embodiment 1 of the present invention, between currents flowing from the magnetic brush charger and the charging roller to a photosensitive member and a quality of an output image;

FIG. 4 is a view showing the configuration of a charging apparatus in the embodiment 2 of the present invention;

FIG. 5 is a table showing results of evaluation on a correlation, in case charging biases are applied to magnetic brush chargers in the embodiment 2 of the present invention, between currents flowing from the magnetic brush chargers to a photosensitive member and a quality of an output image;

FIG. 6 is a schematic view showing the configuration of a known image forming apparatus;

FIG. 7 is a schematic view showing the configuration of an image forming apparatus embodying the present invention;

FIG. 8 is a chart showing the relationship between an applied voltage to an auxiliary charging roller (auxiliary charging roller application voltage) and a charged potential;

FIG. 9 is a chart showing the relationship between an applied voltage to an auxiliary charging roller (auxiliary charging roller application voltage) and a current in a charging sleeve of a magnetic brush charging apparatus; and

FIG. 10 is a chart showing the relationship between a charged potential and an endurance run number (output copy number) in case of a control in an embodiment of the invention.

### DESCRIPTION OF THE PREFERRED EMBODIMENTS

In the following, the present invention will be explained by embodiments thereof with reference to accompanying drawings.

(Embodiment 1)

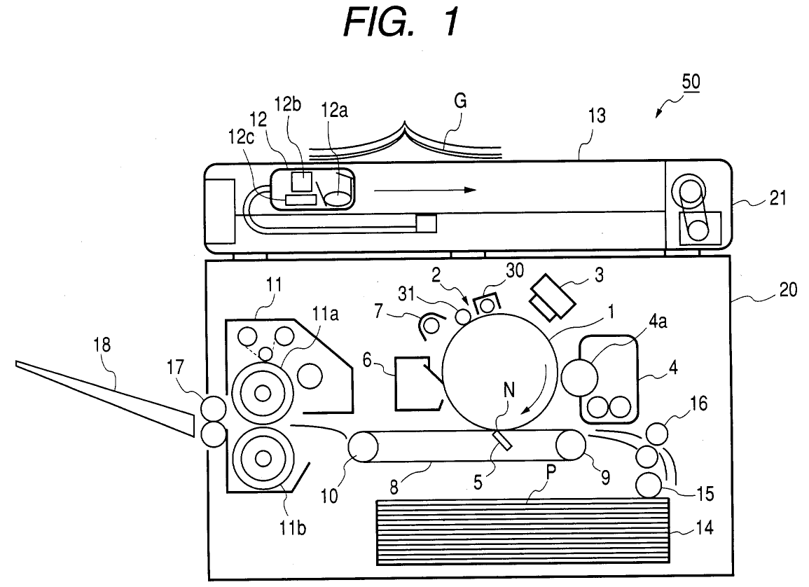

FIG. 1 is a schematic view showing the configuration of an image forming apparatus (a copying apparatus in the present embodiment) in which a charging apparatus of an embodiment 1 of the present invention is applicable.

As shown in FIG. 1, an image forming apparatus (copying apparatus) 50 of the present embodiment includes a printer unit 20 for executing an image formation by an electrophotographic process, and a reader unit (image reading unit) 21.

The printer unit 20 is provided with a negatively chargeable photosensitive member 1 constituting a member to be charged (image bearing member), and, around the photosensitive member 1 and along a rotating direction thereof, there are provided a charging apparatus 2, an exposure apparatus 3, a developing apparatus 4, a transfer charging blade 5, a cleaning apparatus 6 and a pre-exposure lamp 7. Also a fixing device 11 is provided at a downstream side, in a conveying direction of a transfer material, of a transfer nip N formed between the photosensitive member 1 and the transfer blade 5.

In the present embodiment, the photosensitive member 1 is constituted by a negatively chargeable a-Si photosensitive member, which is rotated in a direction of an arrow (clockwise) at a predetermined peripheral speed (300 mm/sec in the present embodiment).

The charging apparatus 2 is provided with a magnetic brush charger (charging device) 30 of an injection charging method for executing a main charging, and a charging roller 31 constituting a contact charging member for executing an auxiliary charging (a detailed configuration of the magnetic brush charger 30 and the charging roller 31, featuring the present invention, and a charging bias application control to the photosensitive member 1 will be explained later).

The exposure apparatus 3 in the present embodiment is a laser beam scanner (exposure apparatus) including a laser diode (semiconductor laser), a polygon mirror etc., and outputs a laser light which is intensity modulated according to time-sequential electrical digital pixel signals of desired image information, thereby executing an image exposure L on the uniformly charge surface of the photosensitive drum 1. Such image exposure forms an electrostatic latent image corresponding to the desired image information, on the surface of the photosensitive drum 1.

The developing apparatus 4 includes a developing sleeve 4a on which toner is coated in a thin layer. The toner, of which thickness is regulated by a limiting blade (not shown) is supported on the surface of the developing sleeve 4a, and is carried by the rotation of the developing sleeve 4a to a developing position (developing unit) opposed to the surface of the photosensitive member 1.

The transfer charging blade 5 is in contact with the photosensitive member 1 in the transfer nip portion N across an endless transfer belt 8. The transfer charging blade 5, receiving a predetermined transfer bias 5, executes a charging of a polarity opposite to that of the toner from the rear surface of the transfer material P, whereby a toner image on the photosensitive member 1 is transferred onto the transfer material P.

The transfer belt 8, being supported between a drive roller 9 and an idler roller 10, is rotated (moved) by the rotation of the drive roller 9, at a peripheral speed substantially equal to the rotating peripheral speed of the photosensitive member 1. The transfer material P is conveyed, while being supported on an upper belt portion of the transfer belt 8, to the transfer nip portion N.

The fixing device 11 is provided with a fixing roller 11a, incorporating a heater (not shown) and a pressure roller 11b, and the transfer material P conveyed to the fixing device 11 is heated and pressed in the fixing nip portion between the fixing roller 11a and the pressure roller 11b, whereby the toner image is fixed to the surface of the transfer material P.

In the following, there will be explained an image forming operation by the above-described image forming apparatus 30 of the present embodiment.

When a copy start signal is entered into the image forming apparatus 50, the photosensitive member 1 is rotated by a driving apparatus (not shown) in a direction of an arrow (clockwise) at a peripheral speed of 300 mm/sec, and, after a uniform charge elimination by the pre-exposure lamp 7, the surface is uniformly charged to a predetermined negative potential by the charging roller 31 and the magnetic brush charger 30 of the charging apparatus 2 to which a charging bias is applied.

On the other hand, in the reader unit 21, an image reading unit 12 integrally formed by an original illuminating lamp 12a, a short-focus lens array 12b and a CCD sensor 12c is moved in a direction indicated by an arrow to illuminate and read an original G placed on an original table 13, whereby a scanning-illuminating light, reflected by the original, is focused by the short-focus lens array 12b and enters the CCD sensor 12c. The CCD sensor 12c includes a light-receiving portion, a transfer portion and an output portion of an unrepresented CCD, in which an optical signal converted by the light-receiving portion of the CCD into a charge signal, which is transferred in succession in the transfer portion in synchronization of a clock pulse to the output portion and further converted therein into a voltage signal, which is outputted after an amplification and a conversion to a lower impedance. An analog signal thus obtained is subjected to a known image processing and converted into a digital signal (image information signal) for supply to the exposure apparatus 3 of the printer unit 20.

Then the exposure apparatus 3 provides the negatively and uniformly charged photosensitive member 1 with an image exposure corresponding to the image information and matching a reversal development process, thereby forming an electrostatic latent image. Then toner bearing a charge is supplied from the developing sleeve 4a of the developing apparatus 4 onto the surface of the photosensitive member 1 in a form matching electrostatic latent image, whereby the latent image is rendered visible as a toner image. The toner in the present embodiment is negatively charged, and the development is executed by a non-contact jumping development.

On the other hand, a transfer material P such as paper, supplied from a cassette 14 by a sheet feed roller 15, is conveyed by registration rollers 16 at a predetermined timing onto the transfer belt 8. The transfer material P, conveyed onto the transfer belt 8, is conveyed by the movement thereof to the transfer nip portion N, where the toner image is transferred by the transfer charging blade 5 to which applied is a transfer bias (of opposite polarity to the toner).

The transfer material P, bearing the transferred toner image, is conveyed by the movement of the transfer belt 8 to the fixing device 11, and, after an image fixation in the fixing nip between the fixing roller 11a and the pressure roller 11b of the fixing device 11, is discharged through conveying rollers 17 to an external discharge tray 18. Residual toner, remaining on the photosensitive member 1 after the transfer, is removed and recovered by the cleaning apparatus 6.

In the following there will be given a detailed explanation on the charging roller 30 constituting first charging means and the magnetic brush charger 30 constituting second charging means in the charging apparatus 2 of the present embodiment.

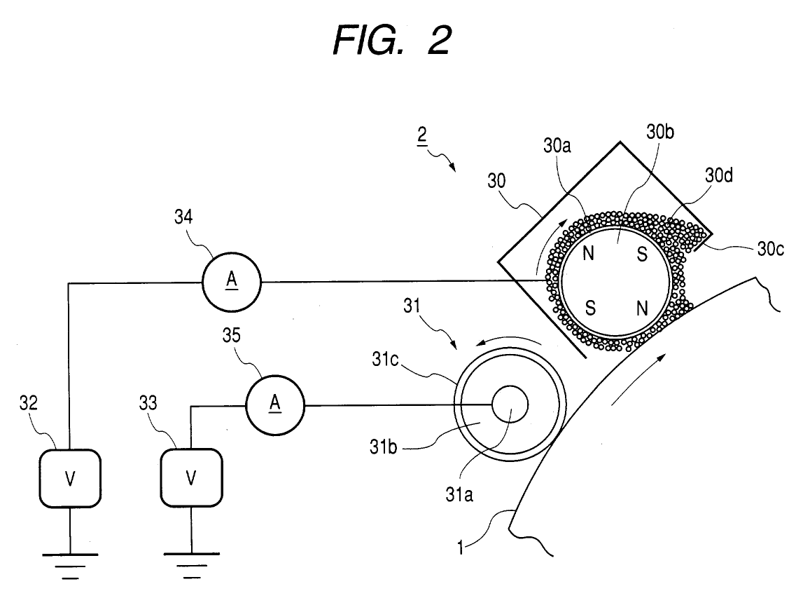

In the magnetic brush charger 30, as shown in FIG. 2, on a charging sleeve 30a, constituting a rotatable non-magnetic magnetic particle carrying member and including therein a fixed magnet roller 30b, conductive magnetic particles 30d form a brush-like structure under a magnetic-field, with a thickness regulated by a magnetic particle regulating member 30c, and the conductive magnetic particles 30d are carried by the rotation of the charging sleeve 30a. A main charging bias source 32 is connected to the charging sleeve 30a and supplies a predetermined charging bias (a negative DC voltage in the present embodiment) thereto, whereby the photosensitive member 1 is given a charge from the conductive magnetic particles 30d and is charged to a potential approximately corresponding to the charging voltage.

The charging sleeve 30a is rotated in a direction indicated by an arrow (clockwise), namely in a direction opposite to that of the photosensitive member 1 in a contact position therewith, at a peripheral speed of 360 mm/sec with respect to the peripheral speed 300 mm/sec of the photosensitive member 1, whereby the surface of the photosensitive member 1 is rubbed by the conductive magnetic particles (magnetic brush layer) 30d with the applied charging bias and is uniformly charged at a desired potential by the injection charging method.

In the magnetic brush charger 30, it is possible to reduce the frictional force and to extend the service life of the photosensitive member 1, by reducing a gap between the magnetic particle regulating member 30c and the charging sleeve 30a thereby decreasing the coated amount of the conductive magnetic particles 30d on the charging sleeve 30a. Also the charging ability of the magnetic brush charger 30 is somewhat lowered by a decrease in the contact points between the conductive magnetic particles 30d and the photosensitive member 1, but such loss of the charging ability can be compensated by the charging of the photosensitive member 1 with the charging roller 31.

The conductive magnetic particles 30d preferably have an average particle size of 10 to 100 μm, a saturation magnetization of 20 to 250 emu/cm³ and a resistance of 10² to 10¹⁰ Ω·cm, preferably 10⁶ Ω·cm or higher in consideration of an eventual insulation defect such as a pinhole on the photosensitive member 1. Also for improving the charging ability, there is preferred a resistance as small as possible. The conductive magnetic particles 30d employed in the present embodiment were formed by ferrite of which surface resistance was regulated by oxidation and reduction, and had an average particle size of 25 μm, a saturation magnetization of 200 emu/cm³ and a resistance of 5×10⁶ Ω·cm.

The charging roller 31 is positioned at an upstream side of the magnetic brush charger 30, with respect to the rotating direction of the photosensitive member 1. The charging roller 31 is constituted by forming, on a conductive metal core 31a, an elastomer layer 31b and a surface layer 31c. Both ends of the metal core 31a are urged by urging members (not shown) toward the photosensitive member 1, whereby the charging roller 31 is pressed under a predetermined pressure to the surface of the photosensitive member 1 thereby forming a stripe-shaped charging nip portion with the photosensitive member 1. The charging roller 31 does not have a driving mechanism and is rotated, in a direction indicted by an arrow (counterclockwise), by the rotation of the photosensitive member 1.

The metal core 31a of the charging roller 31 can be composed for example of iron, aluminum or stainless steel. The elastomer layer 31b can be formed by a solid or foamed solid elastomer such as of urethane, silicone rubber or EPDM (ethylene-propylenediene three-dimensional copolymer), to which carbon or a metal oxide such as TiO₂ or ZnO is added to a volume resistivity of 10⁴ to 10¹³ Ω·cm. Also the surface layer 31c can be formed by a film of a nylon resin such as Toresin (product name), or a synthetic resin such as polyethylene, polyester, fluorinated resin or polypropylene, which is made electrically conductive.

The surface layer 31c preferably has a resistance higher than that of the internal elastomer layer 31b. Such configuration allows to prevent a current concentration even in the presence of a pinhole on the surface of the photosensitive member 1. In the present embodiment, the charging roller 31 was constituted by forming, on an aluminum metal core 31a, an elastomer layer 31b of urethane in which carbon is dispersed for resistance adjustment, and a surface layer 31c of a film of nylon resin which is made electrically conductive.

An auxiliary charging bias source 33 is connected to the metal core 31a of the charging roller 31 and applies a predetermined charging voltage (a bias formed by superposing an AC voltage on a DC voltage) to the metal core 31a, whereby a charge is supplied from the charging roller 31 to the photosensitive member 1 and executes a charging thereof.

In the image forming apparatus 50 of the present embodiment, an evaluation experiment was conducted on a relationship, when charging biases were applied respectively to the magnetic brush charger 30 and the charging roller 31 of the charging apparatus 2, between currents flowing from the magnetic brush charger 30 (charging sleeve 30a and conductive magnetic particles 30d) and the charging roller 31 to the photosensitive member 1, and the image quality of an output image. In this evaluation experiment, a DC voltage of −550V was applied from the main charging bias source 32 to the charging sleeve 30a of the magnetic brush charger 30, while a charging bias, formed by superposing an AC voltage (fixed at a peak-to-peak voltage of 1.2 kV and a frequency of 10 kV) with a DC voltage (variable from −550V to −1200V), was applied from the auxiliary charging bias source 33 to the metal core 31a of the charging roller 31. As shown in FIG. 2, a current flowing in the charging sleeve 30a of the magnetic brush charger 30 was detected by an ammeter 34 constituting current detecting means, while a current in the metal core 31a of the charging roller 31 was detected by an ammeter 35 constituting current detecting means.

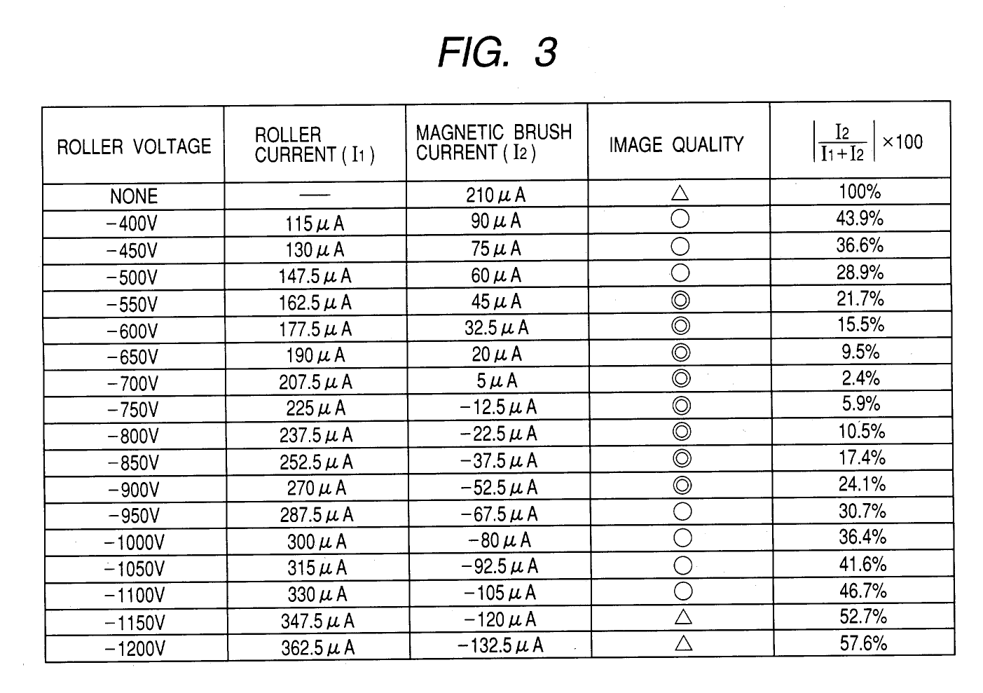

Obtained results are shown in FIG. 3. Also in this evaluation experiment, for the purpose of comparison with the present embodiment, there was also investigated a relationship between a current from the magnetic brush charger 30 to the photosensitive member 1 and the image quality of an output image, in a comparative image forming apparatus which is not provided with the charging roller 31 but with the magnetic brush charger 30 only.

In the evaluation of the image quality of the output image shown in FIG. 3, ⊚ indicates a satisfactory image without unevenness, while O indicates a satisfactory image with limited unevenness, and Δ indicates an unsatisfactory image with conspicuous unevenness, and an evaluation level O or higher is considered practically acceptable.

Referring to FIG. 3, a C-roller voltage indicates a voltage applied to the charging roller 31, while a C-roller current indicates a current supplied to the charging roller 31, and a magnetic brush current (current flowing in the magnetic brush charger 30, namely current flowing from the magnetic brush charger 30 to the photosensitive member 1) has a positive or negative sign respectively when the current flow in a forward direction or in a reverse direction with respect to the applied DC voltage. Namely, a current of a positive sign (“+” being omitted in FIG. 3) indicates a charging while a current of a negative sign indicates a charge elimination.

Also in FIG. 3, |I2/(I1+I2)|×100 indicates an absolute value of a proportion of a current I2, flowing from the magnetic brush charger 30 to the photosensitive member 1, to the entire current flowing from the charging apparatus 2 to the photosensitive member 1 (namely the current in the charging roller 31 (C-roller current I1)+the current flowing from the magnetic brush charger 30 to the photosensitive member 1 (magnetic brush current I2)).

Such proportions of the currents (I1, I2) are represented by the absolute value because the current in the magnetic brush charger 30 (magnetic brush current I2) may be in a charging direction or in a charge eliminating direction, and an important factor is a small magnitude of the current flowing in the magnetic brush charger 30.

As will be apparent from the result shown in FIG. 3, extremely satisfactory output images evaluated as an image quality level ⊚ in case |I2/(I1+I2)|×100 was about 25 (%) or lower. In order to satisfy this relationship, it is preferred to control the voltage applied by the power source 33 to the charging roller 31 according to the current detected by the ammeter 34. Otherwise, it is also possible to control the respective output voltages of the power sources 32, 33 according to the currents detected by the ammeters 34, 35.

In consideration of the deterioration of the image quality resulting in the course of prolonged running operation, there is desired an initial setting providing an image quality level ⊚, or namely a setting where |I2/(I1+I2)|×100 becomes about 25 (%) or lower.

As will be apparent from the results shown in FIG. 3, in case the surface of the photosensitive member 1 is charged by the charging roller 31, in a position immediately in front of the magnetic brush charger 30, to a potential approximately same as the voltage applied to the magnetic brush charger 30, the potential on the photosensitive member 1 is further smoothed by the magnetic brush charger 30 whereby the unevenness in the charging can be prevented and a satisfactory image can be obtained.

This phenomenon can be explained by a fact that, in case the potential difference between the surface potential of the photosensitive member 1 and the voltage applied to the magnetic brush charger 30 is small, a time required for charging the surface of the photosensitive member 1 to a predetermined potential is sufficiently smaller than a passing time through the charging nip portion (contact portion) between the photosensitive member 1 and the magnetic brush charger 30 whereby the surface of the photosensitive member 1 converges to the predetermined potential.

(Embodiment 2)

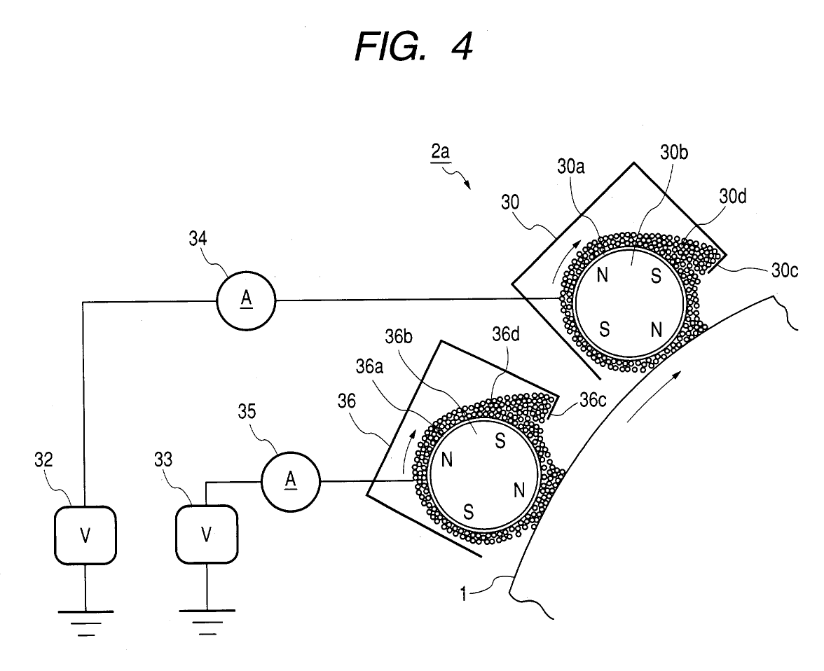

FIG. 4 is a schematic view showing the configuration of a charging apparatus 2a of an image forming apparatus constituting an embodiment 2 of the present invention, wherein components equivalent to those in the embodiment 1 shown in FIG. 2 are represented by same numbers and will not be explained further. In the image forming apparatus, configurations other than the charging apparatus 2a are same as those of the image forming apparatus shown in FIG. 1.

The charging apparatus 2 of the embodiment 1 is provided with the magnetic brush charger 30 for main charging (second charging) and the charging roller 31 for auxiliary charging (first charging), but the charging apparatus 2a of the present embodiment is provided, instead of the charging roller, with a magnetic brush charger 36 of an injection charging method as second charging means. The magnetic brush charger 36 is positioned at the upstream side of the magnetic brush charger 30 with respect to the rotating direction of the photosensitive member 1. Other configurations are similar to those in the embodiment 1.

In the magnetic brush charger 36, like the magnetic brush charger 30, on a charging sleeve 36a, constituting a rotatable non-magnetic magnetic particle carrying member and including therein a fixed magnet roller 36b, conductive magnetic particles 36d form a brush-like structure under a magnetic field, with a thickness regulated by a magnetic particle regulating member 36c, and the conductive magnetic particles 36d are carried by the rotation of the charging sleeve 36a.

An auxiliary charging bias source 33 is connected to the charging sleeve 36a and supplies a predetermined charging bias (a DC voltage in the present embodiment) thereto, whereby the photosensitive member 1 is given a charge from the conductive magnetic particles 36d and is charged to a potential approximately corresponding to the charging voltage.

The charging sleeve 36a is rotated, like the charging sleeve 30a, in a direction indicated by an arrow (clockwise), namely in a direction opposite to that of the photosensitive member 1 in a contact position therewith, at a peripheral speed of 360 mm/sec with respect to the peripheral speed 300 mm/sec of the photosensitive member 1, whereby the surface of the photosensitive member 1 is rubbed by the conductive magnetic particles (magnetic brush layer) 36d with the applied charging bias and is uniformly charged at a desired potential by the injection charging method.

As in the embodiment 1, an evaluation experiment was conducted on a relationship, when charging biases were applied respectively to the magnetic brush chargers (charging device) 30, 36 of the charging apparatus 2, between currents flowing from the magnetic brush chargers 30, 36 to the photosensitive member 1, and the image quality of an output image. The currents were measured with the ammeters 34, 35. In this evaluation experiment, a DC voltage of −550V was applied from the main charging bias source 32 to the charging sleeve 30a of the magnetic brush charger 30, while a DC voltage (−200V to −1000V) was applied from the auxiliary charging bias source 33 to the charging sleeve 36a of the magnetic brush charger 36.

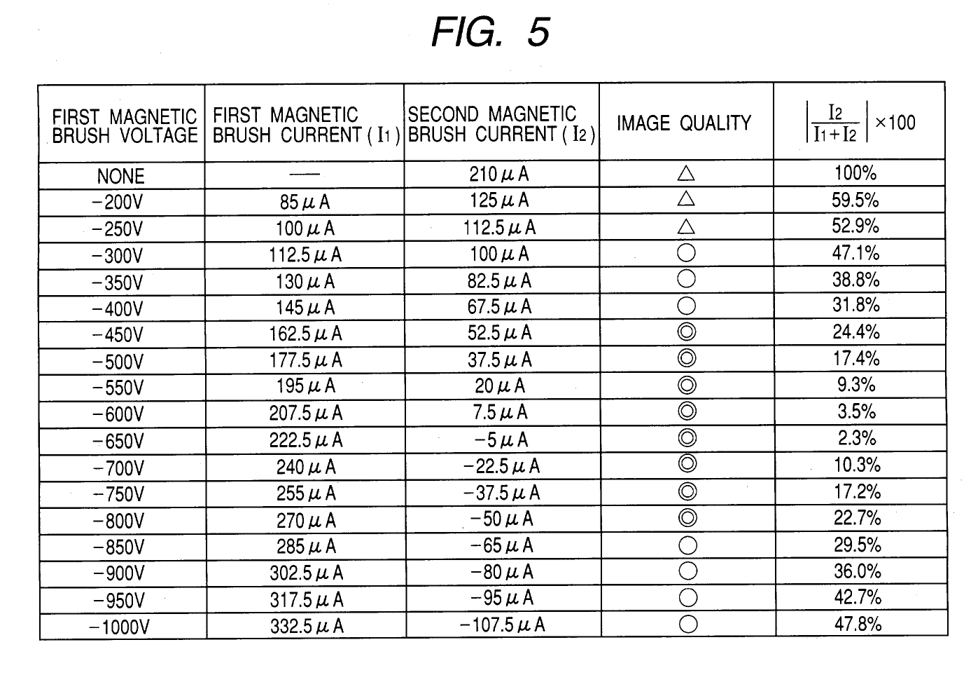

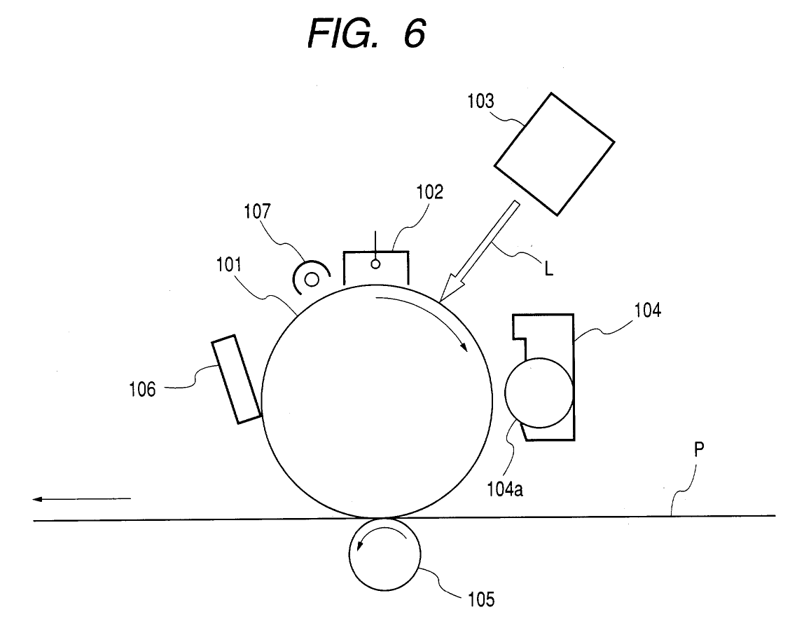

Obtained results are shown in FIG. 5. Also in this evaluation experiment, for the purpose of comparison with the present embodiment, there was also investigated a relationship between a current from the magnetic brush charger 30 to the photosensitive member 1 and the image quality of an output image, in a comparative image forming apparatus which is not provided with the magnetic brush charger 36 but with the magnetic brush charger 30 only.

In the evaluation of the image quality of the output image shown in FIG. 5, ⊚ indicates a satisfactory image without unevenness, while o indicates a satisfactory image with limited unevenness, and Δ indicates an unsatisfactory image with conspicuous unevenness, and an evaluation level O or higher is considered practically acceptable.

Referring to FIG. 5, a first magnetic brush (voltage, current) indicates a voltage and a current I1 of the magnetic brush charger 36, and a second magnetic brush current (current of the magnetic brush charger 30) I2 to the photosensitive member 1 has a positive or negative sign respectively when the current flows in a forward direction or in a reverse direction with respect to the applied DC voltage. Namely, a current of a positive sign (“+” being omitted in FIG. 5) indicates a charging while a current of a negative sign indicates a charge elimination.

Also in FIG. 5, |I2/(I1+I2)|×100 indicates an absolute value of a proportion (%) of a current I2, flowing from the magnetic brush charger 30 to the photosensitive member 1, to the entire current flowing from the charging apparatus 2a to the photosensitive member 1 (namely the current in the magnetic brush charger 36 (first magnetic brush current I1)+the current flowing from the magnetic brush charger 30 to the photosensitive member 1 (second magnetic brush current I2)). Such proportions of the currents (I1, I2) are represented by the absolute value because the current in the magnetic brush charger 30 (magnetic brush current I2) may be in a charging direction or in a charge eliminating direction, and an important factor is a small magnitude of the current flowing in the magnetic brush charger 30.

As will be apparent from the result shown in FIG. 5, extremely satisfactory output images evaluated as an image quality level ⊚ in case |I2/(I1+I2)|×100 was about 25 (%) or lower. In order to satisfy this relationship, it is preferred to control the voltage applied by the power source 33 to the charging roller 31 according to the current detected by the ammeter 34. Otherwise, it is also possible to control the respective output voltages of the power sources 32, 33 according to the currents detected by the ammeters 34, 35.

In consideration of the deterioration of the image quality resulting in the course of prolonged running operation, there is desired an initial setting providing an image quality level ⊚, or namely a setting where |I2/(I1+I2)|×100 becomes about 25 (%) or lower.

As will be apparent from the results shown in FIG. 5, in case the surface of the photosensitive member 1 is charged by the magnetic brush charger 36, in a position immediately in front of the magnetic brush charger 30, to a potential approximately same as the voltage applied to the magnetic brush charger 30, the potential on the photosensitive member 1 is further smoothed by the magnetic brush charger 30 whereby the unevenness in the charging can be prevented and a satisfactory image can be obtained.

This phenomenon can be explained by a fact that, in case the potential difference between the surface potential of the photosensitive member 1 and the voltage applied to the magnetic brush charger 30 is small, a time required for charging the surface of the photosensitive member 1 to a predetermined potential is sufficiently smaller than a passing time through the charging nip portion (contact portion) between the photosensitive member 1 and the magnetic brush charger 30 whereby the surface of the photosensitive member 1 converges to the predetermined potential.

In the foregoing embodiment, DC voltages alone are applied to the magnetic brush chargers 30, 36, but an overlapping of an AC voltage shortens the time required for the surface of the photosensitive member. 1 to converge to the predetermined potential, thereby being advantageous for the charging step. Also in such case, the applied charging biases can be determined, as in the foregoing embodiment, so as to minimize the DC current at the last charging.

In the foregoing embodiments 1 and 2, as explained in the foregoing, it is possible to charge the surface of the image bearing member at a uniform potential without generation of an unevenness in the charging ability, thereby providing a satisfactory image, by setting voltage applying conditions to the plural charging means in such a manner that the proportion (%) of the current flowing from the charging means positioned in the most downstream position in the moving direction of the charged member, among the plural charging means, with respect to the entire current flowing from all the plural charging means to the charged member, becomes 25 % or less.

(Embodiment 3)

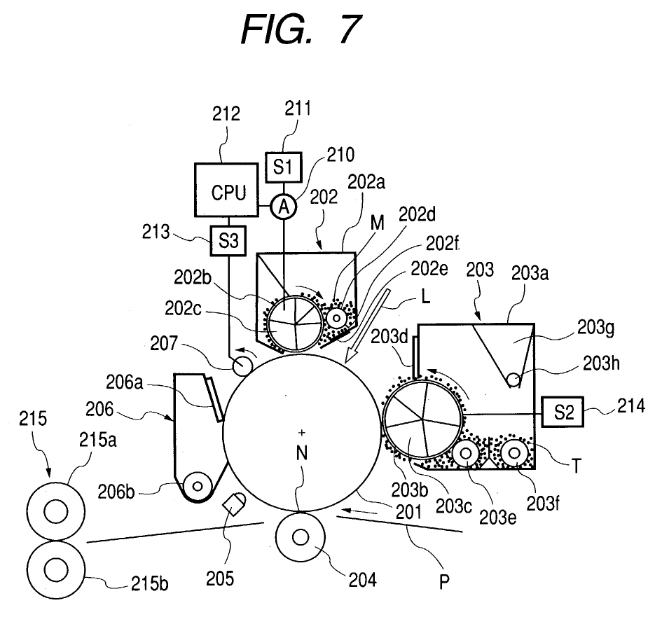

FIG. 7 is a schematic view showing the configuration of another image forming apparatus in which the charging apparatus of the present invention is applicable, and this image forming apparatus is provided with a magnetic brush charging apparatus as main charging means (second charging means) and an auxiliary charging roller as a sub charging means (first charging means).

The image forming apparatus is provided with a drum-shaped electrophotographic photosensitive member (hereinafter called photosensitive drum) 201 constituting an image bearing member, and, around and a rotating direction of the photosensitive member 201, there are provided a magnetic brush charging apparatus 202 as main charging means, a developing apparatus 203, a transfer roller 204, a charge eliminating lamp 205, a cleaning apparatus 206 and an auxiliary charging roller 207 as sub charging means. Also a fixing apparatus 205 is provided at a downstream side, in a conveying direction of a transfer material, of a transfer nip N formed between the photosensitive drum 201 and the transfer roller 204.

In the present embodiment, the photosensitive member 201 is constituted by a negatively chargeable organic photosensitive member, which is provided, on an aluminum cylinder of a diameter of 30 mm, with a charge generation layer formed by dispersing a diszo pigment in a resin, a charge transport layer formed by dispersing hydrazone in a polycarbonate resin, and an organic photosensitive layer constituted by an outermost (surface) charge injection layer, formed by dispersing ultra fine SnO₂ particles in a photosettable acryl resin, and is rotated by a drive mechanism (not shown) in a direction of an arrow (clockwise) at a peripheral speed of 100 mm/sec. Also the surface layer of the photosensitive drum 201 has a resistance of 10⁹ to 10¹⁴ Ω·cm.

The charging apparatus 202 of the injection charging method is provided with a charging container 202a, a charging sleeve 202b constituting a rotatable contact charging member of a diameter of 30 mm and incorporating a fixed magnet roller 202c, conductive magnetic particles M carried on the charging sleeve 202b and serving to inject a charge in contact with the photosensitive drum 201, an agitating screw 202d, *and a regulating blade 202e for coating the surface of the charging sleeve 202b with the magnetic particles M in a uniform thickness.

The charging sleeve 202b is positioned with a gap of 500 μm to the photosensitive drum 201, and is rotated in a direction indicated by an arrow (clockwise) with a peripheral speed of 150 mm/sec.. A charging bias source (S1) 11 supplies the charging sleeve 202b with a charging bias formed by superposing an AC voltage of a peak-to-peak voltage of 500 Vpp and a frequency of 1 kHz with a DC voltage Vm of −600 V. The fixed magnet roller 202c has five magnetic pole peaks in the rotating direction (clockwise) of the charging sleeve 202b, constituting a repulsive pole configuration in which magnetic pole peaks of a same polarity are mutually adjacent. In the present embodiment, the magnetic roller 202c generates a magnetic flux density of 950×10⁻⁴ T on the charging sleeve 202b.

The magnetic particles M are retained on the charging sleeve 202b by a magnetic retaining force of the fixed magnetic roller 202c, and are subjected to a thickness regulation by the regulating blade 202e. An excessively low peripheral speed of the charging sleeve 202b results in an insufficient contact probability between the surface of the photosensitive drum 1 and the magnetic particles M, thus leading to an image defect such as an uneven charging, while an excessively high peripheral speed causes scattering of the magnetic particles M.

A peripheral speed capable of satisfactory charging, though dependent on the external diameter of the charging sleeve 202b and the gap to the photosensitive drum 201, is preferably within a range of 50 to 250 mm/sec in the present embodiment.

At an upstream side of the regulating blade 202e in the rotating direction of the charging sleeve, there is formed a reservoir 202f for the magnetic particles M, and the agitating screw 202e agitates the magnetic particles M in the reservoir 202f along a generatrix of the charging sleeve 202b. The agitating screw 202e is constituted by oval fins (not shown) mounted in alternate directions, and can agitate the magnetic particles M in the reservoir 202f without causing a deviation therein.

As the magnetic particles M, there can be advantageously employed any of following (a), (b) and (c):

(a) a mixture of resin and magnetic powder such as magnetite, kneaded and formed into particles, or a mixture thereof with conductive carbon or the like for resistance adjustment; (b) sintered magnetite or ferrite, or such substance of which resistance is adjusted by reduction or oxidation; and (c) foregoing magnetic particles coated with a resistance-adjusted coating material (for example phenolic resin in which carbon is dispersed) or plated with a metal such as Ni to a suitable resistance.

The magnetic particles M, if the resistance is excessively high, are incapable of uniform charge injection into the photosensitive drum 201, thus resulting in a fogged image caused by small charging failures. On the other hand, if the resistance is excessively low, the current concentrates to a pinhole eventually present on the surface of the photosensitive drum 201, whereby the surface of the photosensitive drum 201 cannot be charged and causes a charging failure in the form of the charging nip.

Consequently, the magnetic brush charging apparatus 202 preferably has an electrical resistance of 1×10⁴ to 1×10⁹ Ω, particularly 1×10⁴ to 1×10⁷ Ω. An electrical resistance of the magnetic brush charging apparatus 202 less than 1×10⁴ Ω tends to result in a leakage through pinholes, while, with an electrical resistance exceeding 1×10⁹ Ω, satisfactory charge injection tends to become difficult to realize. Also in order to control the resistance within the above-mentioned range, the magnetic particles M preferably have a volumic resistivity within a range of 1×10⁴ to 1×10⁹ Ω·cm, more preferably 1×10⁴ to 1×10⁷ Ω·cm.

The magnetic particles M employed in the present embodiment had a volume-averaged particle size of 30 μm, an apparent density of 2.0 g/cm³, a resistance of 1×10⁶ Ω, and a saturation magnetization of 58 A·m²/kg. The particle size of the magnetic particles M affects the charging ability and charge uniformity. An excessively large particle size reduces the contacts with the photosensitive drum 201, thus resulting in an uneven charging. On the other hand, an excessively small particle size increases the charging ability and the uniformity but reduces the magnetic force acting on each particle, thereby enhancing sticking to the photosensitive drum 201.

Therefore, the magnetic particles M having a particle size of 5 to 100 μm can be advantageously employed. In the present embodiment, the magnetic particles M are employed in a total amount of 200 g, and are entirely gradually agitated by the agitating screw 202d and an agitating effect of the repulsive poles of the fixed magnetic roller 202c.

The auxiliary charging roller 207 is positioned at an upstream side, in the rotating direction of the photosensitive drum 201, of the magnetic brush charging apparatus 202. The auxiliary charging roller 207 is constituted by a stainless steel metal core of a diameter of 6 mm, and an EPDM layer of a thickness of 3 mm in which carbon black is dispersed and which is formed by dip coating, and is thus formed as a roller member of an external diameter of 12 mm having a surface layer serving as an elastic layer and a resistance controlling member.

The elastic layer of the auxiliary charging roller 207 is not limited to the foregoing but can also be composed, for example, of urethane, SBR, EVA, SBS, SEBS, SIS, TPO, EPM, NBR, IR, BR, silicone rubber or epichlorhydrine rubber, in which there may be added, if necessary, carbon black, carbon fibers, a metal oxide, metal powder, or a solid electrolyte such as a hydrogen peroxide salt or a conductivity providing material such as a surfactant.

Also the resistance controlling member can be a resin or a rubber such as polyamide, polyurethane, fluorine, polyvinyl alcohol, silicone, NBR, EPDM, CR, IR, BR or hydrine rubber, in which a conductive or insulating filler or additive may be mixed. The above-mentioned materials may be used in any combination as long as the auxiliary charging roller 207 finally has an electrical resistance of 1×10³ to 1×10¹⁰ Ω. The auxiliary charging roller 207 employed in the present embodiment had an electrical resistance of 1×10⁸ Ω.

Both ends of the metal core of the auxiliary charging roller 207 are biased by biasing members (not shown) toward the photosensitive drum 201, whereby the auxiliary charging roller 207 is pressed under a predetermined pressure to the surface of the photosensitive drum 201 thereby forming a stripe-shaped charging nip portion with the photosensitive drum 201. The auxiliary charging roller 207 does not have a driving mechanism and is rotated, in a direction indicted by an arrow (counterclockwise), by the rotation of the photosensitive drum 201.

An auxiliary charging bias source (S3) 213 applies a DC voltage to the metal core of the auxiliary charging roller 207. The auxiliary charging bias source (S3) 213 is controllable by a control apparatus (CPU) 212 constituting control means, and can control a DC voltage Vs, applied to the auxiliary charging roller 207, within a range of −600 V to −2 kV.

In the developing apparatus, a rotatable developing sleeve 203b, incorporating a fixed magnet roller 203c, is provided at an aperture of the developing container 203a, and a developer (toner) T contained in the developing container 203a is coated by a regulating blade 203d in a thin layer on the developing sleeve 203b and is carried to a developing portion opposed to the photosensitive drum 201. The developing sleeve 203b is rotated by a driving apparatus (not shown) in a direction indicated by an arrow (clockwise), with a peripheral speed of 150 mm/sec in the present embodiment. The developer T in the developing container 203a is uniformly agitated and moved toward the developing sleeve 203b by the rotation of agitating members 203e, 203f.

In the present embodiment, the developer T in the developing container 203a is a two-component developer, formed by a mixture of negatively chargeable toner of a particle size of 8 μm and positively chargeable magnetic carrier of a particle size of 50 μm, with a toner concentration of 5 wt. %. The toner concentration is controlled by a detection with an optical toner concentration sensor (not shown), and is maintained constant by suitably replenishing toner from a toner hopper 203g into the developing container 203a by a feeding roller 203h.

In the following, there will be explained an image forming operation by the above-described image forming apparatus.

At the image forming operation, the photosensitive drum 201 is rotated by a driving apparatus (not shown) in a direction indicated by an arrow (clockwise) at a peripheral speed of 100 mm/sec, and is uniformly charged to a negative predetermined potential by an injection charging by the aforementioned magnetic brush charging apparatus 202. Then an exposure L is given by a laser light (wavelength 680 nm) from an exposure apparatus (not shown) corresponding to an input image signal, whereby the potential on the photosensitive drum 201 is lowered in a portion subjected to the exposure L, thereby forming an electrostatic latent image.

The electrostatic latent image is reversal development by the negative developer (toner), coated as a thin layer on the developing sleeve 203b of the developing apparatus 203, thereby providing a visible toner image. In this operation, the developing bias source (S2) 214 supplies the developing sleeve 203b with a developing bias, which is formed, in the present embodiment, by superposing a DC voltage Vde of −500 V with an AC voltage of a peak-to-peak voltage of 2 kVpp and a frequency of 2 kHz.

At a timing when the toner image on the photosensitive drum 201 reaches the transfer nip portion N, a transfer material P such as paper is conveyed to the transfer nip portion N. The transfer roller 204, receiving a transfer bias of a polarity (positive) opposite to that of the toner, exerts an electrostatic force, generated between the photosensitive drum 210 and the transfer roller 204, thereby transferring the toner image from the photosensitive drum 201 onto the transfer material P conveyed to the transfer nip N.

Then the transfer material P, bearing the transferred toner image, is conveyed to the fixing apparatus 215, and, after a thermal fixation of the toner image to the transfer material P by heat and pressure in the fixing nip between the fixing roller 215a and the pressure roller 215b of the fixing apparatus 215, is discharged to the exterior.

On the other hand, the surface of the photosensitive drum 201 after the image transfer is subjected to a charge elimination by an irradiation of a charge eliminating light (central wavelength 660 nm) from a charge eliminating lamp 205, and residual toner remaining on the surface of the photosensitive drum 201 is scraped off by a cleaning blade 206a of the cleaning apparatus 206 and recovered into a used toner container (not shown) by the rotation of a conveying screw 206b.

After the removal of the residual toner, the photosensitive drum 201 is charged in advance to a predetermined negative potential by the auxiliary charging roller 207 receiving a voltage (auxiliary charging bias) from the auxiliary charging bias source (S3) 213, then enters a next image forming cycle and further charged by the magnetic brush charging apparatus 202.

In the present embodiment, the condition of voltage application to the auxiliary charging roller 207 was determined in the present embodiment in the following manner.

In the present embodiment, at the application of the charging bias from the charging bias source (S1) 211 to the charging sleeve 202b of the magnetic brush charging apparatus 202, the charging current was detected by an ammeter 210, and the control apparatus (CPU) 212 controlled the voltage application to the charging sleeve 202b so as to minimize the charging current. As explained in the embodiments 1 and 2, it is preferred that the detected current becomes 25% or less of the entire current.

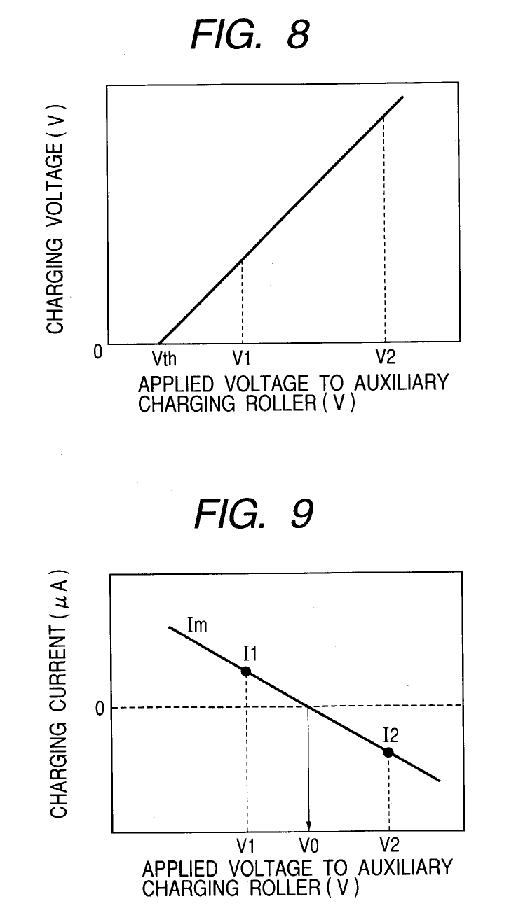

The auxiliary charging roller 207 employed in the present embodiment executes a contact charging of corona discharge type, and the charged potential increases linearly from a discharge threshold value Vth as shown in FIG. 8, in which abscissa indicates a voltage applied to the auxiliary charging roller while ordinate indicates a charged potential.

Therefore, there stands a relation Vd1=Vth+Vs. wherein Vd1 is a charged-potential by the auxiliary charging roller 207, and Vs is a voltage applied to the auxiliary charging roller 207. Thus, there are selected two values for Vs satisfying a relation V2>V1, within the linear range of Vd1. In case a DC voltage Vm is applied to the charging sleeve 202b of the magnetic brush charging apparatus 202, a resulting charging current Im becomes proportional to the potential of the photosensitive drum immediately in front of the charging position.

Therefore, as shown in FIG. 9, the charging current Im can be represented by a first-order approximation to Vs, in the linear range of the charged potential Vd1. In FIG. 9, abscissa indicates a voltage applied to the auxiliary charging roller, and ordinate indicates a charging current in the charging sleeve 202b. These characteristics are utilized to determine the voltage applied to the auxiliary charging roller 207 so as to minimize the absolute value of the charging current Im.

More specifically, in a state where a DC voltage Vm is applied from the charging bias source 211 to the charging sleeve 202b of the magnetic brush charging apparatus 202, voltages V2, V1 are applied from the auxiliary charging bias source 213 to the auxiliary charging roller 207, and charging currents I1, I2 flowing in the charging sleeve 202b are measured with an ammeter 10.

Then, as shown in FIG. 9, an inclination of a line Im (first-order equation) passing through the charging currents I1, I2 is determined, and a value V0 is determined from a crossing point of the line Im and a line of charging current=0. Such value V0 is selected as the voltage Vs applied from the auxiliary charging bias source (S3) 213 to the auxiliary charging roller 207.

The discharge threshold Vth of the auxiliary charging roller 207 may fluctuate for example by a change in the environmental conditions, but it is desirable to select the values V2 and V1 sufficiently large so as not to be influenced by such fluctuation.

The aforementioned voltage application control to the auxiliary charging roller 207 may be conducted for every image forming cycle, or for every predetermined number of image forming cycles.

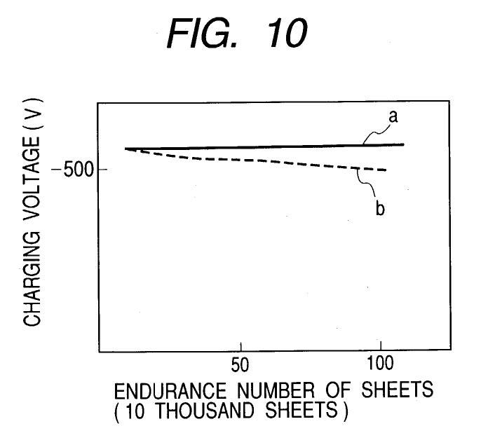

On the image forming apparatus of the present embodiment in which the voltage determined as explained in the foregoing is applied to the auxiliary charging roller 207, an evaluation experiment was conducted on a relationship between a charged potential and an endurance run sheet number (number of image outputs). In FIG. 10, a line a indicates the relationship between the charged potential and the endurance run sheet number (number of image outputs) in case of a control of the present embodiment, while a line b indicates the relationship in a comparative example in which the control of the present embodiment was not adopted. In the example of the present embodiment indicated by the line a in FIG. 10, the control was made at every 100 sheets. Also the comparative example indicated by the line b in FIG. 11 had a same configuration as that of the present embodiment except that a constant voltage of −1 kV was applied to the auxiliary charging roller.

As will be apparent from the results shown in FIG. 10, in case of the control of the present embodiment, the charge potential scarcely changed for an increase of the endurance run sheet number (number of image outputs). On the other hand, in the comparative example without control of the present embodiment, the charged potential was lowered by an increase in the resistance resulting from a deterioration of the auxiliary charging roller, with an increase in the endurance run sheet number (number of image outputs).

As explained in the foregoing, the present embodiment allows to obtain a stable charged potential over a prolonged period, by a control in the control apparatus 212, based on the current detected by the ammeter 210, so as to minimize the absolute value of the current flowing in the charging sleeve 202b of the magnetic brush charging apparatus 202, thereby determining the condition of voltage application to the auxiliary charging roller 207.

Also the present embodiment does not require the potential sensor for measuring the surface charged potential of the photosensitive drum 201, for each of the charging apparatuses (magnetic brush charging apparatus 202, auxiliary charging roller 207), so that the positioning of various members (developing apparatus 203, cleaning apparatus 206 etc.) around the photosensitive drum 201 is not restricted.

The present embodiment employs the magnetic brush charging apparatus 202 as main charging means and the auxiliary charging roller (roller charging member) 207 as sub charging means, but such configuration is not restrictive and the present invention is likewise applicable to a case where a conductive fur brush, a conductive blade, a conductive sponge roller etc. are employed in the main charging means and the sub charging means.

Also the present embodiment employs a predetermined fixed voltage applied to the magnetic brush charging apparatus 202 constituting the main charging means, but such voltage may be rendered variable according to a change in the characteristics of the photosensitive drum 201 and the developing apparatus 203.

Also the present embodiment employs an organic photosensitive drum as the photosensitive drum 201, but such configuration is not restrictive and there may be employed, for example, a photosensitive drum having a surface layer of amorphous silicon or a photosensitive drum having a surface layer of amorphous carbon.

As explained in the foregoing, the present embodiment 3 allows to obtain a stable charged potential over a prolonged period, thereby providing a satisfactory image, by setting a condition of voltage application from the second voltage application means to the sub charging means based on a current in the main charging means, detected by current detecting means.

It is naturally possible to employ the embodiments 1, 2 and 3 in a suitable combination. For example the photosensitive member or the charged member in the embodiment 1 or 2 may be applied to the embodiment 3, and that of the embodiment 3 may be applied to the embodiment 1 or 2.

The present invention is not limited to the foregoing embodiments, but is subject to any and all modifications within the technical scope of the present invention.

What is claimed is:

1. A charging apparatus comprising:
plural charging means for charging a member to be charged, the plural charging means including first charging means and second charging means provided in a most downstream position in a moving direction of said member to be charged;
wherein an absolute value of a current flowing from the second charging means to said member to be charged is 25% or less of an absolute value of a sum of currents respectively flowing from said plural charging means to said member to be charged.

2. A charging apparatus according to claim 1, wherein said second charging means is a magnetic brush charging device including a magnetic brush in contact with said member to be charged.

3. A charging apparatus according to claim 2, wherein said magnetic brush charger includes a rotatable magnetic particle bearing member for bearing magnetic particles.

4. A charging apparatus according to claim 2, wherein said first charging means includes a rotatable charging member provided in contact with said member to be charged.

5. A charging apparatus according to claim 4, wherein said charging member includes an elastic member.

6. A charging apparatus according to claim 2, wherein said first charging means includes a magnetic brush charging device having a magnetic brush in contact with said member to be charged.

7. A charging apparatus according to claim 1, wherein said member to be charged is an image bearing member for bearing an image.

8. A charging apparatus according to claim 1, wherein said image bearing member includes a photosensitive layer and a surface layer, and said surface layer contains a resin and conductive particles.

9. A charging apparatus according to claim 8, wherein said conductive particles includes SnO₂.

10. A charging apparatus according to claim 7, wherein said image bearing member includes a surface layer containing amorphous silicon.

11. A charging apparatus according to claim 7, wherein said image bearing member includes a surface layer containing amorphous carbon.

12. A charging apparatus according to claim 7, wherein said image bearing member is an amorphous silicon photosensitive member.

13. A charging apparatus according to claim 7, wherein said image bearing member includes a surface layer of a resistance of 10⁹ to 10¹⁴ Ω·cm.

14. A charging apparatus according to claim 7, wherein said image bearing member is a photosensitive member, and said photosensitive member is subjected to a charge elimination by exposure means at an upstream side of said first charging means in the moving direction of said photosensitive member.

15. A charging apparatus according to claim 1, comprising detect-ion means for detecting a current flowing said second charging means, and voltage application means for applying a voltage to said first charging means according to the current detected by said detection means.

16. A charging apparatus according to claim 1, wherein a voltage applied to said first charging means and a voltage applied to said second charging means have a same polarity.

17. A charging apparatus comprising:
first charging means for charging a member to be charged;
second charging means provided in a downstream side of said first charging means in a moving direction of said member to be charged;
detection means for detecting a current flowing in said second charging means; and
voltage application means for applying a voltage to said first charging means according to the current detected by said detection means.

18. A charging apparatus according to claim 17, wherein said second charging means is a magnetic brush charging device including a magnetic brush in contact with said member to be charged.

19. A charging apparatus according to claim 18, wherein said magnetic brush charger includes a rotatable magnetic particle bearing member for bearing magnetic particles.

20. A charging apparatus according to claim 18, wherein said first charging means includes a rotatable charging member provided in contact with said member to be charged.

21. A charging apparatus according to claim 20, wherein said charging member includes an elastic member.

22. A charging apparatus according to claim 18, wherein said first charging means includes a magnetic brush charging device having a magnetic brush in contact with said member to be charged.

23. A charging apparatus according to claim 17, wherein said member to be charged is an image bearing member for bearing an image.

24. A charging apparatus according to claim 17, wherein said image bearing member includes a photosensitive layer and a surface layer, and said surface layer contains a resin and conductive particles.

25. A charging apparatus according to claim 24, wherein said conductive particles includes SnO₂.

26. A charging apparatus according to claim 23, wherein said image bearing member includes a surface layer containing amorphous silicon.

27. A charging apparatus according to claim 23, wherein said image bearing member includes a surface layer containing amorphous carbon.

28. A charging apparatus according to claim 23, wherein said image bearing member is an amorphous silicon photosensitive member.

29. A charging apparatus according to claim 23, wherein said image bearing member includes a surface layer of a resistance of 10⁹ to 10¹⁴ Ω·cm.

30. A charging apparatus according to claim 23, wherein said image bearing member is a photosensitive member, and said photosensitive member is subjected to a charge elimination by exposure means at an upstream side of said first charging means in the moving direction of said photosensitive member.

31. A charging apparatus according to claim 17, comprising detection means for detecting a current flowing said second charging means, and voltage application means for applying a voltage to said first charging means according to the current detected by said detection means.

32. A charging apparatus according to claim 17, wherein a voltage applied to said first charging means and a voltage applied to said second charging means have a same polarity.

33. A charging apparatus according to claim 17, wherein said voltage is applied to said first charging means according to the current detected by said detection means, so as to minimize an absolute value of a current flowing in said first charging means.
